(19) United States
(12) Patent Application Publication
(10) Pub. No.: US 2003/0086092 A1
(43) Pub. Date: May 8, 2003

(54) Method of controlling an evaporative light scattering detector

(76) Inventors: Henry Gangloff, Charenton Le Pont (FR); Michel Dreux, Olivet (FR); Alain Tchapla, Les Ulis (FR); Sylvie Heron, Gif Sur Yvette (FR)

Correspondence Address: BAKER & DANIELS, 111 E. WAYNE STREET, SUITE 800, FORT WAYNE, IN, 46802

(21) Appl. No.: 10/167,820

(22) Filed: Jun. 12, 2002

(30) Foreign Application Priority Data
Jul. 11, 2001 (FR) FR 01 09 202
Mar. 8, 2002 (EP) EP 02 290 580.6

(51) Int. Cl. G01J 5/02

(52) U.S. Cl. 356/437; 250/339.13

(57) ABSTRACT

Method of controlling an evaporative light scattering detector comprising:

a nebulizer which is associated with a nebulization chamber,

an evaporation chamber, and

a detection chamber,

characterized in that at least one parameter influencing the nebulization conditions upstream of the aerosol evaporation chamber is adjusted in such a way as to fix the response coefficient b of the evaporative light scattering detector at a regulating value likely to facilitate the analyses and/or to increase the precision and the reliability thereof, the slope b of the calibration curve being determined by the equation:

Log A=b Logm+Loga

in which A represents the surface of the signal measuring the intensity scattered by one of the compounds to analyze and m represents the mass or the concentration of this compound in the sample.

The present invention relates to a method of controlling an evaporative light scattering detector.

Such a device which is adapted to the analysis of effluents originating particularly from chromatography columns has the advantage of being universal, that is to say it permits the analysis of all of the non-volatile compounds and in particular the inorganic or organic cations and anions contained in a sample, without preparation of this sample nor particular chemical treatment, except perhaps for the transformation of volatile compounds into non-volatile compounds.

The principle of operation of an evaporative light scattering detector is as follows: the compounds to be analysed are transported by a more volatile mobile phase or carrier liquid which is subsequently nebulised and then evaporated at a relatively low temperature (which may be of the order of 40° C.) in such a way that all that remain are residual microparticles—ideally the compounds to be analysed—which can be detected by light scattering.

Thus it is possible in particular for effluents originating from chromatography columns to be analysed directly on condition that a sufficiently volatile mobile phase is chosen in order to be used directly as carrier liquid entering in the evaporative light scattering detector.

The evaporative light-scattering detectors also include:

a nebuliser which is associated with a nebulisation chamber and into which are introduced, on the one hand, a sample constituted by a carrier liquid containing less volatile compounds to be analysed which have been dissolved therein and, on the other hand, a nebulisation gas which permits transformation of the sample into an aerosol,

an evaporation chamber formed by a heated tube in which the carrier liquid is evaporated in order to preserve only microparticles of the compounds to be analysed, and

a detection chamber in which the residual microparticles of the compounds to be analysed are irradiated by radiation originating from a polychromatic or monochromatic source and the light scattered in a different direction from that of the irradiation beam is detected.

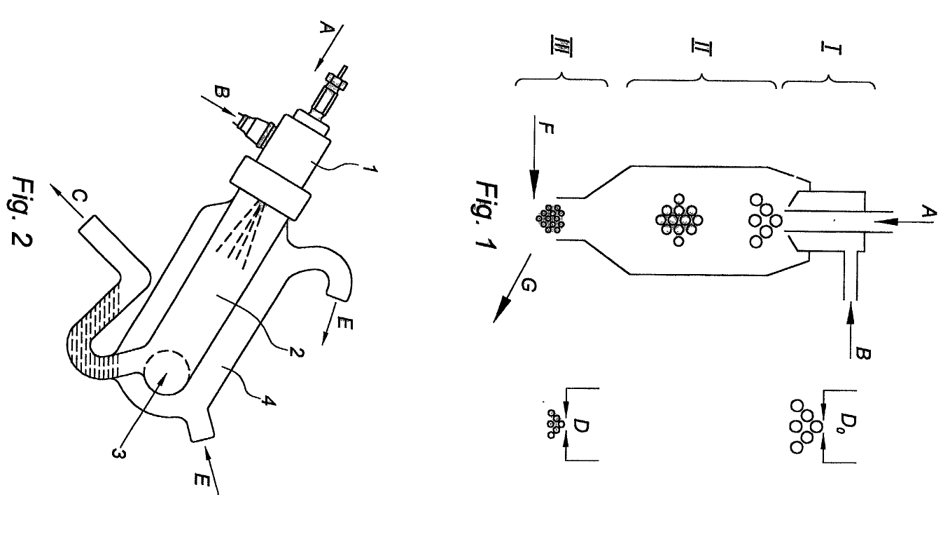

An evaporative light scattering detector is shown schematically by way of example in FIG. 1.

In this drawing this device is composed of an assembly I including a nebuliser 1 associated with a nebulisation chamber 2 shown in detail in FIG. 2, an evaporation chamber II and a detection chamber III.

According to FIG. 2, the sample which is constituted by a carrier liquid in which the compounds to be analysed are dissolved is introduced into the nebuliser 1 through a connecting tube of small diameter according to the arrow A.

At the level of this nebuliser 1 the sample is subjected to the action of a nebulisation gas introduced according to the arrow B in such a way that in the nebulisation chamber 2 situated directly upstream of the nebuliser 1 an aerosol is obtained which consists of droplets of sample having a diameter Do.

More precisely, the nebuliser 1 is a concentric nebuliser of the Venturi type in which the nebulisation gas arrives tangentially via a concentric nozzle in such a way that it coaxially encloses the flow of sample to be analysed.

Therefore the nebulisation chamber 2 serves as a filter in order to permit a narrow distribution of the diameters Do of the aerosol droplets to be obtained: in effect the largest droplets which are situated outside the jet and are slower than the smaller droplets located at the central part thereof are eliminated by condensation on the walls of the nebulisation chamber 2 then discharged according to the arrow C and eliminated with the aid of a siphon; consequently the central part of the jet is practically the only one to be transferred towards to the evaporation chamber II via a central orifice 3.

According to FIG. 2, the nebulisation chamber 2 may be placed in a thermostat-controlled compartment 4 in which a heat-exchanging fluid can be made to circulate according to the arrows E in such a way as to permit the temperature of this chamber to be regulated.

According to FIG. 1, the evaporation chamber II is formed by a simple heated tube, and in particular by a serpent coil at a temperature permitting the evaporation of the carrier liquid transformed into an aerosol.

Consequently at the outlet of this chamber II a mist is obtained which ideally consists of microparticles of the compounds to be analysed of average diameter D.

It should be noted that the prior physical filtering of the largest aerosol droplets makes it possible substantially to reduce the temperature of the evaporation chamber II and thus to reveal more volatile compounds.

At the outlet of the evaporation chamber II the microparticles of the compounds to be analysed are transferred to the detection chamber III in which they are irradiated according to the arrow F by radiation transmitting from a polychromatic or monochromatic source (laser).

The detection chamber III is also equipped with a photomultiplier or a photodiode which permits the detection of the light scattered by the particles of the compounds to be analysed in a direction which is shown schematically by the arrow G and is different from that of the irradiation beam F.

When the evaporative light scattering detector is coupled to a chromatography column situated upstream, a chromatogram is thus obtained which consists of a chronological succession of signals (peaks), each ideally representing one compound of the mixture to be analysed; the surface of these signals (peaks) is a function of the concentration or of the mass of each compound in the initial sample.

More precisely, the intensity I of the light scattered by microparticles of diameter D is a function of the wavelength λ of the irradiation source according to the equation:

$$I = {f ( \frac{D}{λ} )}^{n}$$

The specialists distinguish three domains of light scattering as a function of the dimensions of the irradiated microparticles: the Rayleigh domain for which n=6, the Mie domain for which n=4 and the reflection-refraction domain for which n=2.

These domains are characterised by values of the ratio D/λ respectively <0.1, between 0.1 and 1, and >1.

The diameter D of the light-scattering microparticles can be linked to the diameter D₀ of the aerosol droplets from which they originate by the relationship:

$$D = {{D}_{o} ( \frac{c}{ρ} )}^{1 / 3}$$

in which c and ρ represent respectively the concentration and the density of the compounds to be analysed dissolved in the aerosol droplets.

Consequently the intensity I of the scattered light is a function of the concentration of the compounds to be analysed according to the relationship:

I=f′(c)^{n′}

In this relationship, n′ varies from 2×1/3=0.66 to 6×1/3=2 for the limiting values of the different scattering domains.

Moreover, if A represents the surface of the signal measuring the intensity scattered by a mass m or a concentration c (m=V×c, V being the injected volume) of one of the compounds to be analysed, these two values are linked by the general formula: A=am^{b} or in other words Log A=b Logm+Loga.

The logarithm of the surface of the signal measuring the intensity scattered by a compound to be analysed is therefore a linear function of the logarithm of the mass (or of the concentration) of this compound in the sample.

In order to effect a quantitative analysis, therefore, a calibration curve is traced beforehand and on this is read the mass or the concentration of a compound to be analysed corresponding to the intensity of the light scattered by this compound.

The value of the coefficient b corresponds to the slope of the calibration curve or to the response coefficient of the detector with regard to this particular compound.

In theory, for the different scattering domains mentioned above the slope b of the calibration curve has extreme values of 0.66 and 2.

However, in practice it is rare to observe slopes lower than 1 whilst slopes higher than 2 have already been observed.

The ease of quantitative determination as well as the precision and reliability thereof are to a large extent dependent upon the slope b of the calibration curve.

The specialists have not hitherto sought to devise methods permitting control of the response coefficient of an evaporative light scattering detector, that is to say the slope b of the calibration curve.

The present invention aims to fill this gap by proposing a method of controlling an evaporative light scattering detector which permits the response coefficient of this detector to be fixed at a regulating value likely to facilitate the analyses and/or to increase the precision and the reliability thereof.

According to the invention, to this end the idea has been proposed of attempting to control the slope b of the calibration curve by acting on the ratio D/λ between the diameter D of the light-scattering particles and the wavelength λ of the irradiation source.

Bearing in mind the fact that the wavelength λ is fixed by construction (this is a characteristic of the device), the only parameter on which intervention is sought is the diameter D of the light-scattering particles which depends upon the diameter D₀ of aerosol droplets formed in the nebulisation chamber.

It might therefore be possible to envisage modification of the diameter D of the light-scattering particles by intervening to act on the nebulisation conditions.

Consequently the invention relates to a method of the aforementioned type, characterised in that at least one parameter influencing the nebulisation conditions upstream of the aerosol evaporation chamber is adjusted in such a way as to fix the response coefficient b of the evaporative light scattering detector at a regulating value likely to facilitate the analyses and/or to increase the precision and the reliability thereof. The slope b of the calibration curve is determined by the equation:

Log A=b Logm+Loga

in which A represents the surface of the signal measuring the intensity scattered by one of the compounds to analyse and m represents the mass or the concentration of this compound in the sample.

According to the invention the regulating value can be either a value close to one or a value as large as possible.

In the first case, that is to say when the slope b of the calibration curve is as a close as possible to one or ideally equal to 1, the signal supplied by the evaporative light scattering detector is directly proportional to the mass or to the concentration of the compounds to be analysed.

It goes without saying that such a direct linearity between the intensity of the signal supplied by the device and the quantity of compound responsible for this signal is likely to facilitate the analyses to a large extent and to increase the precision and the reliability thereof in a certain number of cases.

It is also particularly advantageous to obtain a slope b which has the highest possible value; in effect for a given variation of the concentration of a compound to be analysed the intensity of the signal supplied by the device increases all the more as the slope b is large.

Consequently the sensitivity of the determination increases with the value of the slope b of the calibration curve.

According to the invention the parameter or parameters influencing the nebulisation conditions can be chosen from within the group formed by the nature of the nebulisation gas, the temperature of this gas, the flow rate of this gas, the temperature of the nebulisation chamber and the composition of the carrier liquid.

According to the invention it has been observed that the use of helium as nebulisation gas can in certain cases obtain response coefficients very close to 1.

However, the high cost of this rare gas can only inhibit its use in favour of traditional nebulisation gases such as nitrogen (inert gas) or air which are much less expensive.

According to another characteristic of the invention, it has been observed that it is possible to obtain response coefficients close to those obtained with helium by virtue of a controlled addition, in air or nitrogen, of a certain proportion of additive which does not necessarily have a high volatility, in particular water or an alcohol such as ethanol.

According to another characteristic of the invention, two parameters which influence the nebulisation conditions are adjusted at the same time.

In effect it has been established that it is possible to obtain an effect of synergy which facilitates obtaining a response coefficient close to 1 or having a maximum value.

According to the invention it has also been possible in particular to observe that a modification, even a slight one, of the composition of the carrier liquid, following the addition of agents to modify the very diverse chemical nature before the nebulisation can facilitate not only the obtaining of a response coefficient b close to 1 but also the obtaining of a response coefficient b which has the highest possible value.

Such modifying agents may be any organic or inorganic solvents at variable concentrations, preferably volatile ones.

In effect, a solvent which is not very volatile inevitably creates an additional background noise and obliges evaporation to be effected at a higher temperature, which is detrimental in particular to the detection of the solutes of medium volatility.

As has been indicated above, the method according to the invention applies in a particularly advantageous manner to the control of an evaporative light scattering detector coupled to a chromatography column situated upstream in which a mobile phase is used which is sufficiently volatile to be used directly as carrier liquid entering in the detector.

Thus it was possible to fix the response coefficient b of the evaporative light scattering detector at a regulating value close to one or at a maximum value by adding to the eluent upstream of the detector a given concentration of a modifying agent.

In this context, according to another characteristic of the invention it may be advantageous in a first step to choose a carrier liquid which permits fixing of the response coefficient of the evaporative light scattering detector at a regulating value close to one or at a maximum value, then to seek particularly in the literature for the conditions of chromatographic analyses, particularly the stationary phase, using a mobile phase of the same composition as the carrier liquid.

This is a procedure which is the reverse of the usual procedure according to which the conditions of chromatographic analysis are first of all chosen and then the conditions of nebulisation are regulated.

It was possible to confirm the particularly advantageous nature of the process according to the invention by a series of experimental tests, the results of which are set out in the examples below.

These tests were carried out using an evaporative light scattering detector sold by SEDERE under the name SEDEX® which was equipped with a commercial nebuliser (nebuliser NEB 75) with the following physical characteristics:

internal diameter of the tube for introduction of the liquid sample to be analysed 400 micrometers (μm)

diameter of the nozzle permitting the concentric passage of the nebulisation gas 750 micrometers (μm)

that is to say, for the dimensions of the ring of nebulisation gas the values are 700 and 750 μm.

This evaporative light scattering detector was mounted downstream of a liquid phase chromatography column of which the stationary phase was SiC₁₈ and was used for the analysis of solutes having concentrations below 250 ppm (250 mg/liter) belonging to two distinct chemical families (monosaccharides and triglycerides) necessitating mobile phases of the aqueous and non-aqueous type.

### EXAMPLE 1

Study of the Variation of the Response Coefficient of an Evaporative Light Scattering Detector with the Flow of Nebulisation Gas (Air)

A carrier liquid consisting of a mixture of acetonitrile (ACN) and dichloromethane (CH₂Cl₂) 63-37 with a flow rate of 0.7 ml/min was introduced into the detector.

Triglycerides in variable concentrations were injected into the chromatography column and the surfaces of the scattered light signals were measured in order to calculate the response coefficient b.

During this test, the nebulisation gas and the nebulisation chamber were kept at ambient temperature whilst the evaporation chamber was brought to a temperature equal to 37° C.

The following response coefficients (slope b) were obtained:

b=1.60 for a flow rate of nebulisation gas of 0.8 l/min

b=1.52 for a flow rate of nebulisation gas of 1.2 l/min

It should be noted that a flow rate of nebulisation gas which is too low affects the regularity of the nebulisation, whilst a flow rate which is too high affects the scattered light signal which reduces in intensity and in reproducibility.

Consequently this test showed that the response coefficient of the evaporative light scattering detector (slope b) does not vary much with the flow rate of nebulisation gas to the extent that the variations used respect the good operation of the nebuliser, that is to say they guarantee regular and reproducible nebulisation.

### EXAMPLE 2

Variation of the Response Coefficient of the Detector with the Temperature of the Nebulisation Gas (Nitrogen) in Reversed Phase Liquid Chromatography (RPLC), that is to say When the Mobile Phase Consists of an Aqueous Solution

A carrier liquid consisting of a mixture of water and 1% ACN with a flow rate of 1 ml/min was introduced into the detector.

Glucose in variable concentrations (25 to 100 ppm) was injected into the chromatography column and the surfaces of the scattered light signals were measured in order to calculate the response coefficient b.

During this test the nebulisation chamber was maintained at ambient temperature whilst the evaporation chamber was brought to a temperature of 45° C.

The nebulisation gas for its part was successively brought to ambient temperature, to 45° C. and to 65° C. The response coefficients (slope b) thus obtained are set out in Table 1 below:

| b | amb. T° | 45° C. | 65° C. | $\frac{{Δb}_{45 - amb}}{b}$ | $\frac{{Δb}_{65 - 45}}{b}$ | $\frac{{Δb}_{65 - amb}}{b}$ |
|---|---|---|---|---|---|---|
| Nebuliser | 1.59 | 1.31 | 1.26 | −17.6% | −4% | −20.7% |
| NEB 75 | | | | | | |

This test made it possible to confirm that in RPLC the response coefficient of the evaporative light scattering detector (slope b) decreases when the temperature of the nebulisation gas increases.

### EXAMPLE 3

Variation of the Response Coefficient b of the Detector with the Temperature of the Nebulisation Gas (Air) in Liquid Chromatography in a Non-Aqueous Medium

A carrier liquid (mobile phase) consisting of a mixture ACN−CH₂Cl₂ 63−37 with a flow rate of 0.7 ml/min was introduced into the detector.

Triglycerides in variable concentrations were injected into the chromatography column and the surfaces of the scattered light signals were measured in order to calculate the response coefficient b.

During this test, the nebulisation gas and the nebulisation chamber were kept at ambient temperature whilst the evaporation chamber was brought to a temperature of 37° C.

The nebulisation gas for its part was successively brought to ambient temperature, to 45° C. and to 65° C.

The response coefficients (slope b) thus obtained are set out in Table 2 below:

| b | 15° C. | amb. T° | 45° C. | 65° C. | $\frac{{Δb}_{45 - amb}}{b}$ | $\frac{{Δb}_{65 - 45}}{b}$ | $\frac{{Δb}_{65 - 15}}{b}$ |
|---|---|---|---|---|---|---|---|
| Nebuliser | 1.48 | 1.60 | 1.69 | 1.79 | +5.3% | +5.9% | 20.9% |
| NEB 75 | | | | | | | |

This test made it possible to confirm that in liquid chromatography in a non aqueous medium the response coefficient of the evaporative light scattering detector (slope b) decreases when the temperature of the nebulisation gas increases.

The two examples above are appropriate to prove that the response coefficient of an evaporative light scattering detector can vary with the temperature of the nebulisation gas, regardless of whether the carrier liquid is aqueous or not.

The variations observed can be opposed, and depending upon the case the use of temperatures higher or lower than ambient can therefore be envisaged in order to bring the coefficient b towards one.

### EXAMPLE 4

Variation of the Response Coefficient of the Detector with the Nature and the Temperature of the Nebulisation Gas

This test was carried out in the same conditions as the test described in Example 2 but using a detector equipped with a nebuliser having different characteristics (prototype), introducing either nitrogen or helium into it as nebulisation gas and successively bringing this nebulisation gas to ambient temperature, to 45° C. and to 65° C.

The results obtained are set out in Table 3 below:

| b | amb. T° | 45° C. | 65° C. | $\frac{{Δb}_{65 - amb}}{b}$ |
|---|---|---|---|---|
| Nitrogen | 1.56 | 1.44 | 1.42 | −9% |
| Helium | 0.94 | 0.99 | 0.99 | +5.3% |

This test made it possible to confirm that in the simplest experimental conditions the use of helium as nebulisation gas can permit a response coefficient b close to 1 to be obtained directly with glucose in an aqueous medium.

As has already been indicated above, helium does however have the drawback of being expensive, which tends to limit its use.

This drawback has provided an incentive to vary the composition of the traditional nebulisation gases (air, nitrogen) which are much less expensive than helium by a controlled addition of various additives such as water or ethanol.

Thus it was possible for slopes b close to 1.3 to 1.5 with the nebuliser NEB 75 to be brought to values close to one by introducing ethanol into the nebulisation gas.

### EXAMPLE 5

Variation of the Response Coefficient b of the Detector with the Temperature of the Nebulisation Chamber in RPLC, That is to say in an Aqueous Medium

This test was carried out in the same conditions as the test described in Example 2 and by introducing into the nebuliser NEB 75 a nebulisation gas maintained at ambient temperature.

During this test the temperature of the nebulisation chamber was successively brought to 28° C., to 35° C. and to 40° C.

The results obtained are set out in Table 4 below:

| b | 28° C. | 35° C. | 40° C. | $\frac{{Δb}_{35 - 28}}{b}$ | $\frac{{Δb}_{40 - 35}}{b}$ | $\frac{{Δb}_{40 - 28}}{b}$ |
|---|---|---|---|---|---|---|
| Nebuliser | 1.62 | 1.49 | 1.22 | −8% | −18.1% | −24.7% |
| NEB 75 | | | | | | |

This test made it possible to confirm that in chromatography in an aqueous medium the response coefficient of the detector (slope b) decreases when the temperature of the nebulisation chamber increases.

### EXAMPLE 6

Variation of the Response Coefficient b of the Detector with the Temperature of the Nebulisation Chamber in Liquid Chromatography in a Non-Aqueous Medium

This test was carried out in the same conditions as the test described in Example 3 and by introducing into the nebuliser NEB 75 a nebulisation gas maintained at ambient temperature.

During this test the temperature of the nebulisation chamber was successively brought to 15° C., to ambient temperature and to 40° C.

The results obtained are set out in Table 5 below:

| b | 15° C. | amb. T | 40° C. |
|---|---|---|---|
| Nebuliser NEB 75 | 1.25 | 1.60 | 1.63 |

This test made it possible to establish that in chromatography in a non-aqueous medium the response coefficient of the evaporative light scattering detector (slope b) increases when the temperature of the nebulisation chamber increases.

It is known to specialists in the field of thermodynamics that a pneumatic nebulisation is an endothermic phenomenon leading to differences of temperature of the initial liquid and of the corresponding aerosol.

Consequently a cooling of the aerosol is observed which can be attenuated or even eliminated by the calorific energy delivered by heating of the nebulisation chamber.

This heating can vary the size and the size distribution of the aerosol droplets and thus indirectly influences the scattering of the light by the residual microparticles of the compounds to be analysed.

This results in variations of the response coefficient (slope b) of the detector with the temperature of the nebulisation chamber.

Thus it has been established that if the slope b decreases when the temperature increases in an aqueous medium, the opposite is produced in a non-aqueous medium; furthermore, a considerable variation of the scattered intensity (A or LogA) is observed when the temperature increases.

As the yield from the nebulisation changes with the temperature, there are therefore simultaneously more particles which will scatter, but their dimension and their distribution are modified.

### EXAMPLE 7

Variation of the Response Coefficient b of the Detector with the Temperatures of the Nebulisation gas and of the Nebulisation Chamber by the Effect of Synergy

This test was carried out in the same conditions as the tests described in Examples 2 and 3 by introducing into a nebuliser NEB 75 a liquid sample consisting either of an aqueous carrier liquid or of a non-aqueous carrier liquid.

The solutes used in order to calculate b were always respectively glucose and triglycerides.

During this test, the temperature of the nebulisation gas (air) and the temperature of the nebulisation chamber were varied.

The results obtained during this test are set out in Table 6 below:

| Solute | Nebuliser | gas T° | ch neb T° | b* | bₘₐₓ** | Δb/b |
|---|---|---|---|---|---|---|
| Glucose | NEB 75 | 45 | 45 | 1.03 | 1.62 | 57% |
| Triglycerides | NEB 75 | 25 | 15 | 1.25 | 1.81 | 45% |

In this table:
b* corresponds to the minimum value of the slope b obtained for temperature values specified in the preceding columns and
bₘₐₓ** corresponds to the value of the slope b which is most different from one obtained for temperatures of the gas and of the nebulisation chamber which are different from those specified in this table.

This test made it possible to establish that a simultaneous control of the temperature of the nebulisation gas and of the nebulisation chamber makes it possible by the effect of synergy to obtain significant variations of the response coefficient (slope b) of the detector.

In an aqueous medium, and with a detector equipped with the nebuliser NEB 75, a slope of 1.03 is obtained with a nebulisation gas (nitrogen) brought to 45° C. and a nebulisation chamber brought to 45° C.

Different conditions led, conversely, to a slope b of 1.62.

In a non-aqueous medium with air as nebulisation gas, it was only possible to reduce the slope b to 1.25, whilst it was possible to observe slopes of 1.81 in other temperature conditions.

The results mentioned above demonstrate unambiguously that it is possible to modify the response coefficient (slope b) of an evaporative light scattering detector so that it becomes close to one or maximum and to facilitate the quantitative determination.

Example 4 revealed more precisely the importance of the characteristics of the nebuliser without, however, providing a conclusion as to the predominant influence of one characteristic or of another. However, all the conclusions remain identical, but the amplitude of the variations of the slope b can change significantly.

### EXAMPLE 8

Variation of the Response Coefficient of an Evaporative Light Scattering Detector by the Addition of an Organic Solvent—Influence of the Nature of this Solvent

A carrier liquid consisting of the mobile chromatographic phase and of an additional liquid corresponding to a modification of 5% of the mobile phase was introduced into the detector.

More precisely a mobile chromatographic phase ACN−CH₂Cl₂ 65−35 with a flow rate of 1 ml/min and various additional liquids at 0.05 ml/min were used in the case of the analysis of triglycerides (TG).

Variable concentrations (5 to 60 mg/l) of two triglycerides TG 10 (carbon chain with 10 carbon atoms) and TG 18:2 (carbon chains with 18 carbon atoms and two double carbon—carbon bonds) were injected into the chromatography column as model solutes and the surfaces of scattered light were measured without addition and with addition of various organic solvents.

All the conditions linked to the nebulisation and to the evaporation are fixed for this comparison of the values of the slope b.

The response coefficients b thus obtained are set out in Table 7 below:

| | | | | | nitro- |
|---|---|---|---|---|---|
| | | methanol | pentanol | propionitrile | methane |
| b | O | CH₃OH | CH₃(CH₂)₄OH | CH₃CH₂C═N | CH₃NO₂ |
| TG 10 | 1.55 | 1.86 | 1.43 | 1.21 | 1.15 |
| TG 18:2 | 1.55 | 1.87 | 1.40 | 1.25 | 1.07 |

This test made it possible to show that the slope b can increase or decrease according to the nature of the modification of the composition of the mobile chromatographic phase following the addition of an additional liquid downstream of the column.

This test is close to Example 4 in which the nebulisation uses a nebulisation gas with the addition of the ethanol modifier.

The addition of nitromethane brings b close to one both for TG 10 and for TG 18:2. Conversely, methanol significantly increases the slope b. In this latter case the sensitivity of quantitative determination increases since for a given variation of the concentration of a TG the signal increases all the more as b is high.

### EXAMPLE 9

Variation of the Response Coefficient of an Evaporative Light Scattering Detector with the Addition of a Modifier

A carrier liquid consisting of a mobile chromatographic phase (ACN−CH₂Cl₂ 65−35 at 1 ml/min) and of an additional liquid containing a modifier at 0.05 ml/min was introduced into the detector.

The triglycerides TG 10 and TG 18:2 were injected into the chromatography column at variable concentrations (5 to 100 mg/l) and the surfaces of scattered light were measured without and with the addition of a modifier.

All the conditions linked to the nebulisation and to the evaporation are fixed for this comparison of the values of the slope b.

The response coefficients b thus obtained are set out in Table 8 below:

| b | O | *urea | **cholesterol | **TEA/HCOOH |
|---|---|---|---|---|
| TG 10 | 1.45 | 1.23 | 0.51 | 1.23 |
| TG 18:2 | 1.35 | 1.15 | 0.53 | 1.24 |

*the urea is dissolved in ACN 100% at a concentration of 110 μmol in the total flow of 1.05 ml/min.
**the cholesterol and the TEA/HCOOH mixture are in solution in the mobile chromatographic phase (ACN—CH₂Cl₂ 65-35) respectively at concentrations of 110 μmol and 5 mmol in the total flow of 1.05 ml/min.

This test made it possible to show that the slope b can decrease markedly according to the chemical nature of the additive which can form with a triglyceride either weak bonds or bonds corresponding to the formation of true complexes (cholesterol, urea).

According to the theory set out previously, the decrease in the value of the slope b is explained in part by the increase in the size of the solute in the form of aggregate.

### EXAMPLE 10

Variation of the Response Coefficient of an Evaporative Light Scattering Detector with the Addition of a Modifier in Variable Concentration

A carrier liquid, consisting of a mobile chromatographic phase ACN−CH₂Cl₂ 65−35 at a flow rate of 1 ml/min and of an additional liquid at 0.05 ml/min of the same composition in ACN−CH₂Cl₂ 65−35 as the mobile phase but with the addition of cholesterol at variable concentrations, was introduced into the detector.

The triglycerides TG 10 and TG 18:2 were injected as model triglycerides at variable concentrations (5 to 100 mg/l) into the chromatography column and the surfaces of scattered light were measured with the different concentrations of the modifier having led to the greatest decrease in the slope b in the preceding Table 8 (cholesterol).

All the conditions linked to the nebulisation and to the evaporation are fixed for this comparison of the values of the slope b.

The response coefficients b thus obtained are set out in Table 9 below:

| | CHOLESTEROL (10⁻⁶M) | | | | |
|---|---|---|---|---|---|
| | Concentration | | | | |
| B | 0 | *4 | 13.75 | 55 | 110 |
| TG 10 | 1.45 | 1.27 | 0.91 | 0.67 | 0.51 |
| TG 18:2 | 1.35 | 1.30 | 0.85 | 0.74 | 0.53 |

*domain of concentration of TG 30 at 100 mg/l.

This test made it possible to show that the slope b depends directly upon the concentration of the modifier and that the value of b equal to 1 can be obtained for a concentration of the modifier (cholesterol) between 4 and 13.75 μmol.

1. Method of controlling an evaporative light scattering detector comprising:
a nebuliser which is associated with a nebulisation chamber and into which are introduced, on the one hand, a sample constituted by a carrier liquid containing less volatile compounds to be analysed which have been dissolved therein and, on the other hand, a nebulisation gas which permits transformation of the sample into an aerosol,
an evaporation chamber formed by a heated tube in which the carrier liquid is evaporated in order to preserve only microparticles of the compounds to be analysed, and
a detection chamber in which the residual microparticles of the compounds to be analysed are irradiated by radiation originating from a polychromatic or monochromatic source and the light scattered in a different direction from that of the irradiation beam is detected
characterised in that at least one parameter influencing the nebulisation conditions upstream of the aerosol evaporation chamber is adjusted in such a way as to fix the response coefficient b of the evaporative light scattering detector at a regulating value likely to facilitate the analyses and/or to increase the precision and the reliability thereof, the slope b of the calibration curve being determined by the equation:
Log A=b Logm+Loga
in which a represents the surface of the signal measuring the intensity scattered by one of the compounds to analyse and m represents the mass or the concentration of this compound in the sample.

2. Method as claimed in claim 1, characterised in that the regulating value is a value close to one.

3. Method as claimed in claim 1, characterised in that the regulating value is the maximum value possible.

4. Method as claimed in any one of claims 1 to 3, characterised in that the parameter or parameters influencing the nebulisation conditions can be chosen from within the group formed by the nature of the nebulisation gas, the temperature of this gas, the flow rate of this gas, the temperature of the nebulisation chamber and the composition of the carrier liquid.

5. Method as claimed in claim 4, characterised in that helium is used as nebulisation gas.

6. Method as claimed in claim 4, characterised in that air or nitrogen containing a certain proportion of an additive, particularly water or an alcohol such as ethanol, is used as nebulisation gas.

7. Method as claimed in any one of claims 1 to 6, characterised in that two parameters which influence the nebulisation conditions are adjusted at the same time in such a way as to obtain a synergy.

8. Method as claimed in any one of claims 1 to 4, intended for the control of an evaporative light scattering detector coupled to a chromatography column situated upstream in which a mobile phase is used which is sufficiently volatile to be used directly as carrier liquid entering in the evaporative light scattering detector, characterised in that a modifying agent is added to the mobile phase, upstream of the evaporative light scattering detector, in a concentration chosen so as to permit fixing of the response coefficient of the evaporative light scattering detector at a regulating value close to one or at the highest possible value.

9. Method as claimed in claim 8, characterised in that a carrier liquid is chosen which permits fixing of the response coefficient of the evaporative light scattering detector at a regulating value close to one or at the highest possible value, and the system of chromatographic analysis, in particular the stationary phase adapted to this carrier liquid and to the separation sought, is sought.
